(19) United States
(12) Patent Application Publication
(10) Pub. No.: US 2015/0064319 A1
(43) Pub. Date: Mar. 5, 2015

(54) Method of Injection of an Antimicrobial Composition for Rapid Cooling of Poultry During Processing

(71) Applicants: J. Barton Langley, Russellville, AR (US); Trevor W. Nelson, Green Forest, AR (US); Lucas M. Miller, London, AR (US); Andrew C. Estes, Russellville, AR (US); Jeremy B. Estes, London, AR (US)

(72) Inventors: J. Barton Langley, Russellville, AR (US); Trevor W. Nelson, Green Forest, AR (US); Lucas M. Miller, London, AR (US); Andrew C. Estes, Russellville, AR (US); Jeremy B. Estes, London, AR (US)

(21) Appl. No.: 14/538,465

(22) Filed: Nov. 11, 2014

Related U.S. Application Data
(63) Continuation-in-part of application No. 13/579,330, filed on Aug. 16, 2012.
(60) Provisional application No. 61/903,249, filed on Nov. 12, 2013.

(51) Int. Cl. A22C 21/00

(52) U.S. Cl. CPC A22C 21/0061
USPC 426/281

(57) ABSTRACT

A method for rapidly cooling poultry carcasses during processing by injecting the carcasses with a composition including water and an antimicrobial agent. The composition may be in slush ice form or liquid form. The antimicrobial agent, such as peroxide, plays a critical role in this method. The antimicrobial agent serves to lower the freezing point of the chilled water of the composition below 32 degrees F., which allows greater heat exchange when the chilled water composition is injected into the warm interior of the carcasses. The antimicrobial agent also prevents bacterial contamination of the carcasses as a result of the possible transfer of bacteria from the exterior surface of the carcasses into the interior of the carcasses during injection.

### CROSS-REFERENCE TO RELATED APPLICATIONS

This application claims the benefit of U.S. Provisional Application No. 61/903,249, entitled “Apparatus and Method of Injection of a Chilled Water Antimicrobial Composition and Slush Ice for Rapid Cooling of Poultry During Processing” and filed on Nov. 12, 2013. This application is a continuation-in-part application of, and claims the benefit of, U.S. patent application Ser. No. 13/579,330, entitled “Method and Apparatus for Chilled Water Injection” and filed on Aug. 16, 2012, which is the national phase application of International Application No. PCT/US2011/00358, entitled “Method and Apparatus for Chilled Water Injection” and filed on Feb. 25, 2011. The complete disclosure of said patent applications are hereby incorporated by reference.

### STATEMENT REGARDING FEDERALLY SPONSORED RESEARCH OR DEVELOPMENT

Not applicable

### BACKGROUND OF THE INVENTION

1. Field of the Invention

The present invention relates to the processing of poultry and, in particular, to a method of injection of an antimicrobial composition for the rapid cooling of freshly slaughtered and eviscerated poultry during processing.

2. Brief Description of the Related Art

In modern poultry processing plants, the birds are first slaughtered and then eviscerated. The eviscerated carcasses are at a temperature of around 38° C. (100° F.) and must be cooled rapidly to avoid the proliferation of bacteria. The cooling of the eviscerated carcasses is typically carried out in a chiller which comprises a chilled water bath in a tank. The eviscerated carcasses are maintained in the chiller for a sufficient residence time to chill them to a temperature only slightly above the freezing point of water. Poultry chillers of the “auger type” commonly used in poultry processing are described in U.S. Pat. Nos. 6,089,037 and 6,397,622. Such chillers can be in excess of 100 feet in length in order to obtain sufficient residence time to chill the poultry carcasses to the desired final temperature. The residence time depends on the rate of heat transfer from the carcasses to the chilled water and is limited by the rate of heat transfer from the interior of the poultry carcass to the surface of the poultry carcass. In addition, pre-chillers and post-chillers may also be used to extend the residence time of the poultry carcasses in the chilled water. Chillers therefore have a large “footprint” in a poultry processing plant and it is desirable to reduce this footprint and to reduce the processing time, both for the sake of efficiency and to reduce the potential for bacterial contamination.

Injectors are used in poultry processing to introduce liquids containing salts, flavoring agents, marinates and the like into the poultry carcasses. These injectors use a plurality of needles to inject the liquids under pressure into the flesh of the poultry carcasses. An example of an injector is described in U.S. Pat. No. 5,505,972. References mentioned in this background section are not admitted to be prior art with respect to the present invention. The limitations of the prior art are overcome by the present invention as described below.

### BRIEF SUMMARY OF THE INVENTION

The present invention is comprised of a method for rapidly cooling poultry carcasses during processing by injecting the carcasses with an antimicrobial composition. The composition may in slush ice form or purely liquid form. The antimicrobial agent (e.g. peroxide) plays two critical roles in this method. First, the antimicrobial agent serves to lower the freezing point of the chilled water of the composition below 32 degrees F., which allows greater heat exchange when the chilled water composition is injected into the warm interior of the carcasses. In addition, the lower freezing point changes the crystalline structure of the slush ice as it is formed. Instead of the ice crystals having jagged edges, the ice crystals have rounded edges. These round edges allow the slush ice to be pumped and injected into the carcasses. Second, the antimicrobial agent also prevents bacterial contamination of the carcasses as a result of the possible transfer of bacteria from the exterior surface of the carcasses into the interior of the carcasses during the injection step. The present invention is also directed to an apparatus for injecting the antimicrobial composition.

These and other features, objects and advantages of the present invention will become better understood from a consideration of the following detailed description of the preferred embodiments and appended claims in conjunction with the drawings as described following:

### BRIEF DESCRIPTION OF THE DRAWINGS

FIG. 1 is a side elevation view of an auger-type chiller having the injection apparatus mounted to an entrance end of the chiller.

### DETAILED DESCRIPTION OF THE INVENTION

In the first preferred embodiment, the present method is directed to the injection of a chilled water-antimicrobial composition 16 in liquid form into freshly slaughtered and eviscerated poultry carcasses during poultry processing. While the injection of chilled water alone into the warm interior of the carcass is able to immediately begin the chilling process, there is a risk of introducing bacteria (e.g. salmonella and E. coli) from the surface of the poultry carcass into the interior of the carcass. To alleviate this risk of bacterial contamination caused by the injection step, the present method includes injecting a composition, which includes chilled water and an antimicrobial agent, into the carcass. The antimicrobial agent preferably is peroxide, but it may alternatively be any microbial agent capable of achieving the benefits described herein that would be well-known to those skilled in the art. The amount of the antimicrobial agent used in the composition and the ratio of water to antimicrobial agent in the composition will depend upon the antimicrobial agent used and industry standards.

The antimicrobial agent in the composition also serves to lower the freezing point of the chilled water in the composition 16. As a result, the composition 16 is still in liquid form when the composition has a temperature of less than 32 degrees F. The temperature of the composition may be 27 degrees F. or lower without freezing. Because of the lowered temperature of the composition, rapid chilling of the poultry carcasses occurs immediately after injection. In addition, because of the injection into the interior of the warm carcasses, cooling is not limited by the rate of heat transfer from the interior of the carcass to the surface of the carcass. As a result, the carcasses are cooled more rapidly and do not require the extended residence time in the chiller needed for conventional chilling. The length of the chiller can be reduced, pre-chilling and post-chilling eliminated, and bacterial contamination reduced significantly.

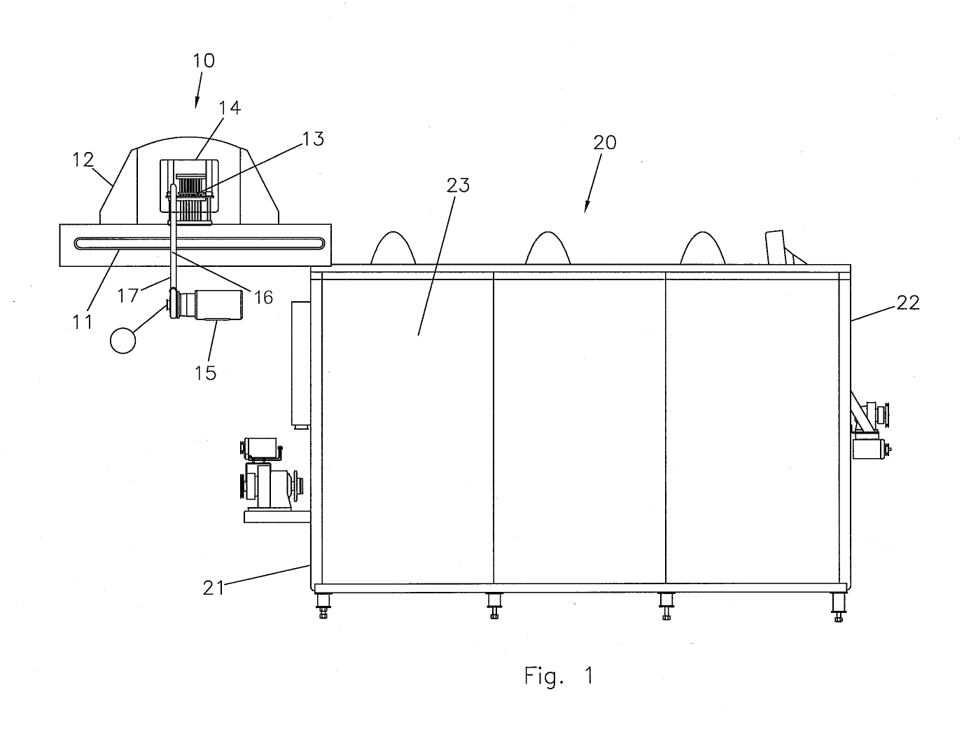

As shown in FIG. 1, an injection apparatus 10 is mounted to an entrance end 21 of a chiller 20. While FIG. 1 illustrates an auger-type chiller, the present invention is not limited to this type of chiller but may be used with any type of chiller. The freshly slaughtered and eviscerated poultry carcasses are removed from a shackle line (not shown) and placed on a conveyor 11 which conveys the warm carcasses past the injector 12. In the injector 12, a plurality of needles 13 are disposed within a head 14. The head 14 may comprise an upper and a lower manifold plate (not shown) providing a conduit though which the chilled water-antimicrobial composition passes. An optional air head may be attached to the head 14 allowing the needles 13 to retract when they encounter a bone in a poultry carcass.

A pump 15 receives the chilled water composition 16 from a source of the chilled water composition, which may be any type of refrigeration apparatus known to those skilled in the art. The pump 15 increases the pressure of the chilled water-antimicrobial composition 16 and delivers the pressurized chilled water composition 16 to the needles 13 through a delivery line 17. The head 14 moves up and down, for example by 10 to 20 centimeters (4 to 8 inches), as the conveyor 11 indexes forward, for example by 10 to 20 centimeters (4 to 8 inches) at a time.

The needles 13 inject the pressurized chilled water composition 16 into the poultry carcasses thereby beginning the chilling process. The chilled water-antimicrobial composition 16 may also include brines, flavorings and other additives as known in the art. In one embodiment, after the injection step, the injected poultry carcasses are immediately introduced into a conventional chiller 20. The carcasses then move from the entrance end 21 to an exit end 22 of the chiller through a counter-flow of chilled water 23. The carcasses are further cooled as they move through the chiller and are contacted by the chilled water in the chiller. At the exit end 22 of the chiller 20, the chilled carcasses are removed by conventional means, such as an unloader, and continue to further processing steps.

In a second preferred embodiment, the antimicrobial composition 16 is in the form of slush ice, and is injected into the poultry carcasses. The injection may occur prior to entering the chiller as described above or after the carcasses are removed from the chiller. In the injector 12, a plurality of needles 13 are disposed within a head 14. The head 14 may comprise an upper and a lower manifold plate (not shown) providing a conduit though which the slush ice composition passes. An optional air head may be attached to the head 14 allowing the needles 13 to retract when they encounter a bone in a poultry carcass. A pump 15 receives the slush ice composition from a slush ice maker of the type well-known to those skilled in the art. The pump 15 increases the pressure of the slush ice composition and delivers the pressurized slush ice composition to the needles 13 through a delivery line 17.

Faster cooling of the carcasses occurs through the injection of the slush ice composition because the slush ice is colder than the liquid composition described above. In addition to the greater temperature difference between the slush ice and the carcasses, most of the heat loss of the carcasses is due to the changing states of the ice as it melts.

The slush ice composition described in the second embodiment is created by freezing the chilled water-antimicrobial composition described in the first embodiment. The antimicrobial agent lowers the freezing point of the composition. The lower freezing point changes the crystalline structure of the slush ice as it is formed. Instead of the ice crystals having jagged edges, the ice crystals have rounded edges. These round edges allow the slush ice to be pumped and injected into the carcasses as described above.

The present invention has been described with reference to certain preferred and alternative embodiments that are intended to be exemplary only and not limiting to the full scope of the present invention.

We claim:

1. A method for rapid cooling of poultry, comprising the step of injecting a poultry carcass with a composition, wherein said composition comprises water and an antimicrobial agent.

2. The method of claim 1, wherein said composition is in a liquid form.

3. The method of claim 1, wherein said composition is slush ice.

4. The method of claim 1, wherein said antimicrobial agent is peroxide.

5. The method of claim 1, wherein said a temperature of said composition is less than 32° F.

6. The method of claim 1, wherein prior to said injection step, said poultry carcass is introduced into a poultry chiller.

7. The method of claim 6, wherein said poultry chiller is an auger chiller.

8. The method of claim 1, wherein subsequent to said injection step, said poultry carcass is introduced into a poultry chiller.

9. The method of claim 8, wherein said poultry chiller is an auger chiller.
